(19) United States
(12) Patent Application Publication
(10) Pub. No.: US 2022/0304342 A1
(43) Pub. Date: Sep. 29, 2022

(54) In-Line Fluid and Filter Sterilization Apparatus

(71) Applicants: Stephen Almeida, Petersburg, FL (US); James Kerr, Scarborough, ME (US)

(72) Inventors: Stephen Almeida, Petersburg, FL (US); James Kerr, Scarborough, ME (US)

(21) Appl. No.: 17/209,848

(22) Filed: Mar. 23, 2021

(51) Int. Cl. A23L 2/50; A47J 31/60; A23L 2/72; B01D 29/92

(52) U.S. Cl. CPC A23L 2/50; A47J 31/60; A23L 2/72; B01D 29/925; A23V 2002/00

(57) ABSTRACT

The present application for patent relates to the field of fluid sterilization and more specifically to devices for the sterilization of fluids that are held in reservoirs as well as sterilization of fluids while they are being delivered. The present application used UVC sterilization radiation to achieve sterilization.

### REFERENCE TO PRIOR FILED APPLICATIONS

This application claims the benefit of U.S. Provisional Application No. 62/994,692 filed 25 Mar. 2020 under 35 U.S.C. § 119(e); which application is incorporated by reference herein in their entirety.

### FIELD OF THE INVENTION

The present application for patent is in the field of fluid sterilization and more specifically is in the field of delivery systems which deliver sterilized fluids on demand.

### BACKGROUND

There are a number of systems in which fluids are stored and maintained until needed, such as, for example, coffee delivery systems, soda machines and other similar devices which deliver fluids on demand from a holding reservoir. These systems can harness and promote growth of bacteria, viruses, molds and other infectious microorganisms within the fluid reservoir as well as any lines or conduits that deliver the fluids, especially when these systems are inactive for short periods of time, allowing the microorganisms to grow and multiply. Even sterilized fluids in a reservoir may pick up infectious microorganisms when the fluids are delivered through lines and conduits that contain the infectious microorganisms.

Currently available solutions to this problem rely on heat as the sole method of killing these microorganisms. While helpful, heat alone cannot kill or deactivate the microorganisms. In the current climate of virus and germ pandemics, new and better ways to prevent distribution of harmful organisms is necessary. Thus, there is a need to further reduce or eliminate harmful microorganisms that reside in fluid delivery systems, both in the reservoirs and delivery lines and conduits.

### BRIEF DESCRIPTION OF THE DRAWINGS

FIG. 1 depicts one embodiment of the current disclosure showing the base of the disclosed device.

FIG. 2 depicts the reservoir of one embodiment of the current disclosure.

FIG. 3 depicts an embodiment of the current disclosure.

FIG. 4 depicts a module embodiment of the current disclosure.

FIG. 5 depicts another module embodiment of the current disclosure.

FIG. 6 depicts the top view of another module embodiment of the current disclosure.

FIG. 7 depicts the side view of FIG. 6

FIG. 8 depicts a further embodiment of the current disclosure, FIG. 8a depicts a top view and FIG. 8b depicts a side view.

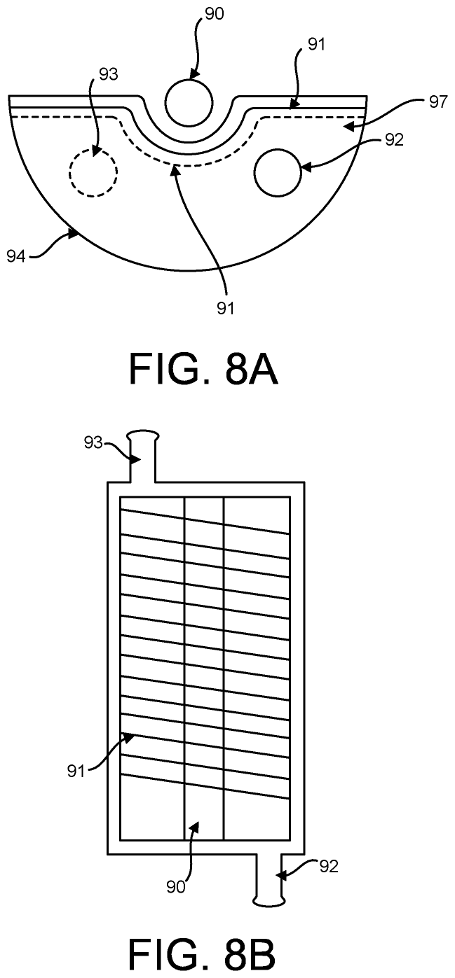

FIG. 9 depicts an example of the current disclosure applied to a coffee making device.

### BRIEF DESCRIPTION

As used herein, the conjunction “and” is intended to be inclusive and the conjunction “or” is not intended to be exclusive unless otherwise indicated. For example, the phrase “or, alternatively” is intended to be exclusive.

As used herein the phrase “at least one” means one or more as desired.

As used herein the term “opaque” means the blocking of the passage of electromagnetic radiation such as, for example, ultraviolet light radiation.

As use herein the term “baffle” refers to flow-directing or obstructing vanes or panes.

In a first embodiment, disclosed and claimed herein is a fluid sterilizing device comprising a reservoir comprising a lid, a bottom and sides for containing a fluid comprised of material which is opaque to UVC radiation, at least one window positioned in the bottom of the reservoir for allowing the passage of UVC radiation into the interior of the reservoir, a base component configured to accept the reservoir comprising at least one UVC emission source positioned at the at least one window and positioned to emit UVC radiation into the interior of the reservoir, wherein the at least one UVC emission source is a UVC cold cathode mercury vapor lamp, a UVC LED or both when more than one UVC source is present and wherein the surface of the lid that is positioned inwardly to the interior of the reservoir has a UVC reflective surface.

In a second embodiment, disclosed and claimed herein is the device of the above embodiment wherein the lid further comprises a shut-off switch configured to disable the UVC transmission from the at least one UVC emission source when the lid opens, and an activation switch situated in the base that activates the UVC emission sources when the reservoir is positioned into or onto the base.

In a third embodiment, disclosed and claimed herein are devices of the above embodiments wherein the UVC emission sources are programmed to activate intermittently, at various intensities and for varying lengths of time.

In a fourth embodiment, disclosed and claimed herein is a fluid sterilizing device comprising a reservoir, comprising a lid, a bottom and sides for containing a fluid comprised of material which is opaque to UVC radiation, wherein the lid is comprised of at least one UVC radiation source positioned in the lid such that, in operation, the UVC emission source emits UVC sterilizing radiation into the interior of the reservoir and wherein the interior of the reservoir my optionally be covered with expanded PTFE.

In a fifth embodiment, disclosed and claimed herein are devices of the above embodiments wherein the at least one UVC emission source is a UVC cold cathode mercury vapor lamp, a UVC LED or both when more than one UVC source is present and wherein the surface of the lid that is positioned inwardly to the interior of the reservoir has a UVC reflective surface.

In a sixth embodiment, disclosed and claimed herein are devices of the above embodiments wherein the lid further comprises a shut-off switch configured to disable the UVC transmission from the at least one UVC emission source when the lid opens, and an activation switch situated in the base that activates the UVC emission sources when the reservoir is positioned into or onto the base.

In a seventh embodiment, disclosed and claimed herein are devices of the above embodiments wherein the UVC emission sources are programmed to activate intermittently, at various intensities and for varying lengths of time.

In an eighth embodiment, disclosed and claimed herein are devices of the above embodiments further comprising an in-line sterilization module configured to receive an output of fluid from the reservoir, comprising, a tubing structure comprised of quartz, FEP or both, situated inside a housing having a UVC reflective interior surface, at least one UVC emission source positioned proximate to the tubing structure, a fluid inlet port and a fluid outlet port, and expanded PTFE reflective materials wrapped around at least a portion of the tubing structure. The tubing structure may be a one bend loop, a spiral loop or combinations thereof.

In an ninth embodiment, disclosed and claimed herein are devices of the above embodiments further comprising an in-line sterilization and filtration module configured to receive an output of fluid from the reservoir, comprising, a filter through which the fluid from the reservoir passes, and a baffling system of at least two vanes, at least one UVC emission source positioned in the module to emit sterilization of the fluid when the fluid passes through the baffle system and wherein the intensity of the UVC emission is programmable.

In a tenth embodiment, disclosed and claimed herein are devices of the above embodiments further comprising an in-line sterilization module configured to receive an output of fluid from the reservoir, comprising a tubing structure comprised in quartz, FEP or both, situated inside a housing having a UVC reflective interior surface, at least one UVC emission source positioned proximate to the tubing structure, a fluid inlet port and a fluid outlet port, and expanded PTFE reflective materials wrapped around at least a portion of the tubing structure. The tubing structure may be a one bend loop, a spiral loop or combinations thereof.

In an eleventh embodiment, disclosed and claimed herein are devices of the above embodiments further comprising an in-line sterilization and filtration module configured to receive an output of fluid from the reservoir, comprising, a filter through which the fluid from the reservoir passes, and a baffling system of at least two vanes, at least one UVC emission source positioned in the module to emit sterilization of the fluid when the fluid passes through the baffle system, wherein the intensity of the UVC emission is programmable.

In a twelfth embodiment, disclosed and claimed herein is a fluid sterilization device for simultaneous sterilization comprising a. a reservoir component comprising a lid, a bottom and sides for storing fluids, b. a tubing system configured to allow the fluids stored in the reservoir to pass through positioned proximate to the reservoir, c. at least one UVC emitting source positioned between the reservoir and the tubing system configured to emit UVC sterilizing radiation into the reservoir containing stored fluids and, simultaneously, the tubing system through which the stored fluids are transported, wherein the at least one UVC emitting source is a cold cathode mercury vapor lamp, a UVC LED or a combination when more than one UVC source is present, wherein the interior surfaces of the components are UVC emission reflective. The tubing system is constructed of corrugated materials which allow UVC sterilizing radiation to pass, wherein the tubing system is constructed of UVC corrugated FEP and connected by silicone connectors.

### DESCRIPTION OF THE DISCLOSURE DETAILED

The current disclosure reduces or eliminates harmful microorganisms that reside in fluid delivery systems such as in fluid reservoirs as well as the tubing systems used to deliver the fluids to a desired site. by either killing them or deactivation them through exposure to UVC sterilizing radiation.

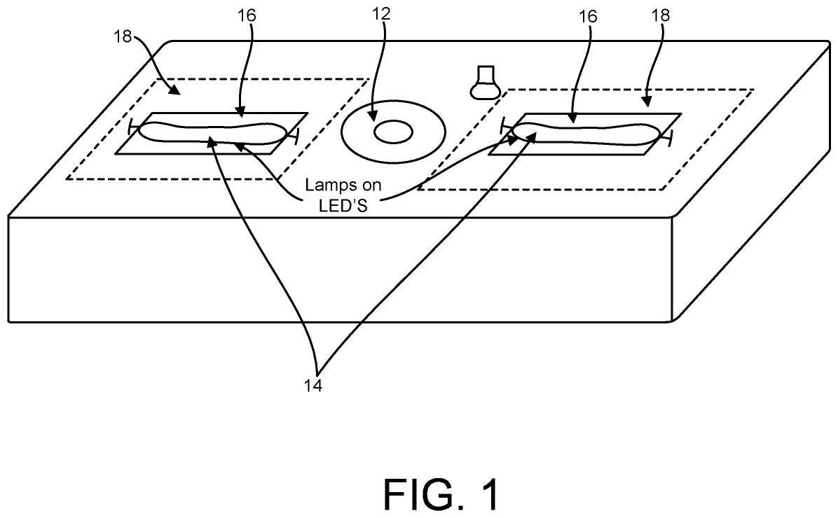

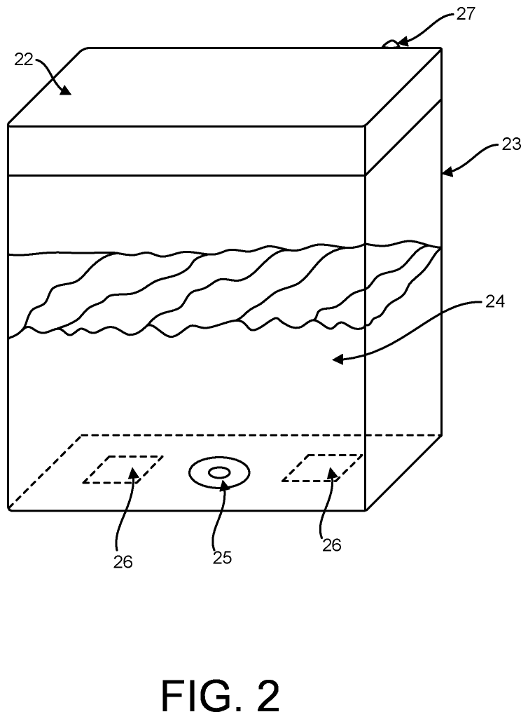

One embodiment is a fluid sterilization device as shown in FIGS. 1 (the reservoir base) and 2 (the reservoir). FIG. 2 shows a reservoir 23 containing a lid 22, a bottom and sided for containing a liquid 24. The reservoir lid, bottom and sides are composed of materials transparent to visible light to allow observation of the interior of the reservoir and are opaque to UVC radiation. Such useful materials include, for example, polycarbonate, polystyrene, polypropylene and the like. The reservoir can be of any shape, such as for example, square, rectangular, cylindrical. In the bottom of the reservoir is at least one window 26 positioned to allow UVC sanitizing radiation to pass though into the inside of the reservoir and into the fluid 24. The windows are made of materials that allow UVC radiation to pass through an enter the interior of the reservoir to sterilize the contents of the reservoir such as, for example, quartz or fluorinated polymer film such as, for example, fluorinated ethylene propylene polymer (FEP). The lid 22 also can have a deactivation switch 27 which disables UVC emission if the lid is opened while the UVC sources are operating. The reservoir may also have inlet and outlet ports 25.

The reservoir is positioned into a base component, FIG. 1. The base has at least one UVC emission source 14 positioned so the, when the reservoir is position on the base, the UC source emit UVC sterilizing radiation through the windows of the reservoir. The UVC emission sources may also contain a thin covering of FEP film 16 for protection, from about 2.0 to about 10 microns, such as, for example, 7 microns. UVC emission sources suitable for the embodiment of the current disclosure include, for example cold cathode mercury vapor lamps, UVC-emitting LEDS and the like as are well known on the industry for the purposed of sterilization. The current disclosures may use one or more types of UVC emission sources depending on the device configuration. The base component may also be containing UVC reflective surfaces 18 to reflect the sterilization radiation back into the fluid to optimize sterilization. UVC reflective surfaces suitable for the current disclosure include, for example, aluminum, expanded PTFE, ethylene-tetrafluoroethylene copolymer (ETFE), or other materials known to reflect UVC radiation. Additionally, the underside of the lid may also have UVC reflective surfaces t further improve sterilization efficiency. The base component may also include inlet ports an outlet ports as needed 12. The base into which the reservoir is situated may further comprise an activation switch that activates the UVC emission sources when the reservoir is positioned into or onto the base.

The UVC emission sources may be configured to activate at various times and for various periods in order to provide the optimum sterilization protocol. The exposure may be short, high intensity light pulsed. For example, in the application of a coffee delivery system, the UVC sources may be programmed to deliver sterilizing radiation for 2 minutes every 15 minutes. The current disclosure is not limited to any time length or time period, for example, if desired, the UC emission source could be activated for 24 hours a day. Fluids suitable to benefit from the current disclosure are those that act as media for the growth and propagation of infectious microorganisms, such as, for example, any aqueous-based systems as used in coffee delivery systems.

The devices of the current disclosure may be configured to be power by external current or have power supplied by batteries or rechargeable batteries.

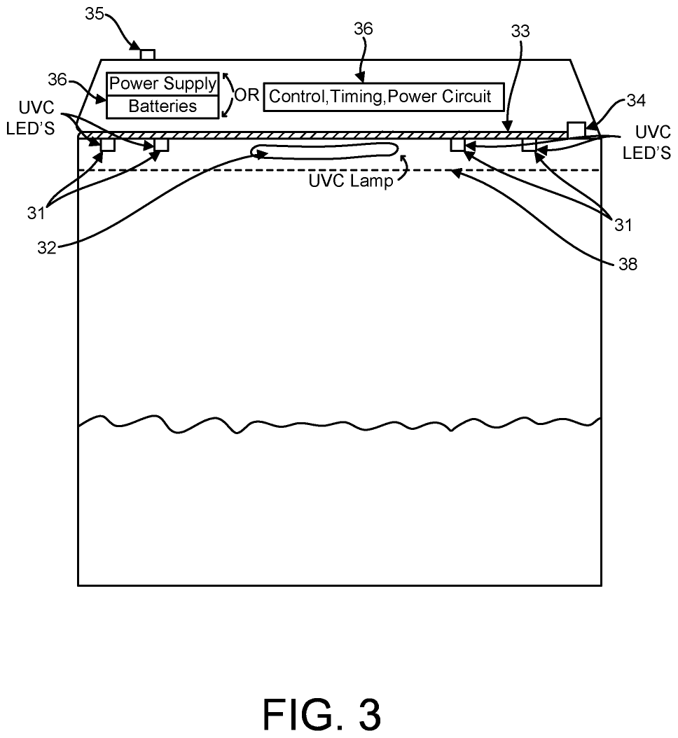

In another embodiment shown in FIG. 3 is a fluid sterilization device wherein the sterilizing components are housed in the lid of the device. In this embodiment, one UVC lamp 32 and a number of UVC-emitting LEDs 31 are shown positioned on the underside of the lid directed into the inside of the reservoir. A UVC reflective layer 33 is positioned between the UVC emission sources and the remaining underside of the lid. The lid may also contain a safety switch 34 configured to deactivate the UVC sources if the lid is removed from the reservoir. A timing activation switch 35 may also be present. Include in the lid in 36 FIG. 3 and the base in FIG. 1 (not shown) are the electronics which run the device, including emission energy, emission time, emission frequency as well pulse emission protocol.

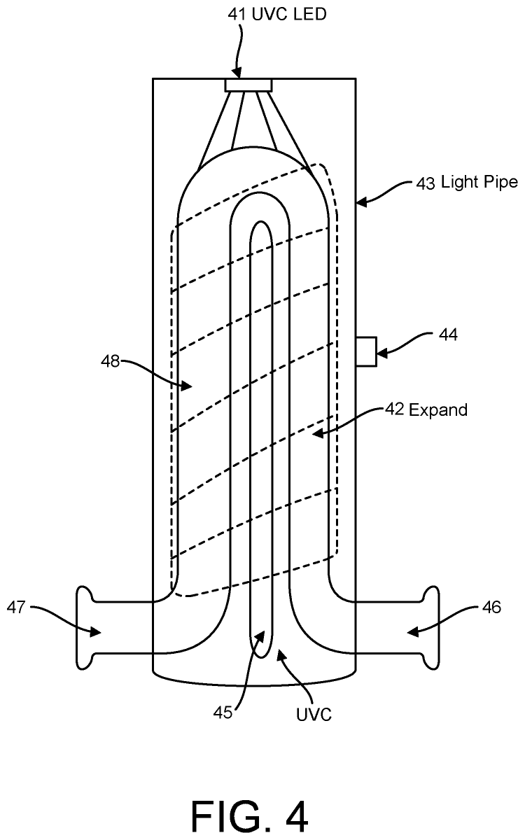

In another embodiment are devices that further contain an in-line sterilization module configured to receive fluid from the reservoir or base of the above embodiments shown in FIG. 4. The modules are configured to be attached to the reservoir or base such that fluid that has been sanitized flow though the module and exits to a desired location. The module is configured to continue the sterilization of the fluids as well to sterilize the tubing module itself. The module of FIG. 4 contains a tubing structure 48, which in this example is a single loop. The tubing may be constructed of quartz, FEP or both. A UVC emitting LED 41 is position at the bend in the tube directed toward the fluid flowing through. The tubing system may contain an expanded PTFE wrap 42 designed to capture and reflect UVC sterilizing radiation back into the fluid. The tubing system is housed in a UVC reflecting housing 43 again designed to capture and reflect UVC sterilizing radiation back into the fluid. A light pipe 44 may be present to notify the user that the system is functioning and the UVC emission is active. In this example a UVC lamp 45 is situated in the center of the tubing loop to provide sterilizing radiation. Inlet and outlet sections of the tubing 46 and 47 are shown.

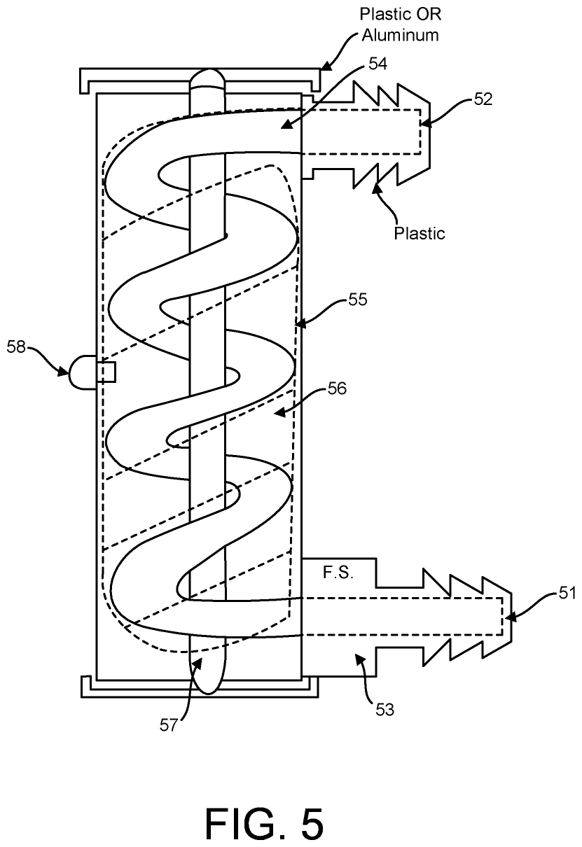

FIG. 5 shows an example of an inline sterilization module wherein the tubing structure 54 is a spiral. As above, the module contains and inlet port 52, an outlet port 51, a light pipe 58, expanded, PTFE wrap 56, and aluminum UVC-reflective surfaces 55. The module of this example also contains a UVC light positioned in the middle vortex of the spiral offering maximum efficiency for sterilization as the residence time of the fluid under sterilization is maximized. The module also includes a flow sensor 53.

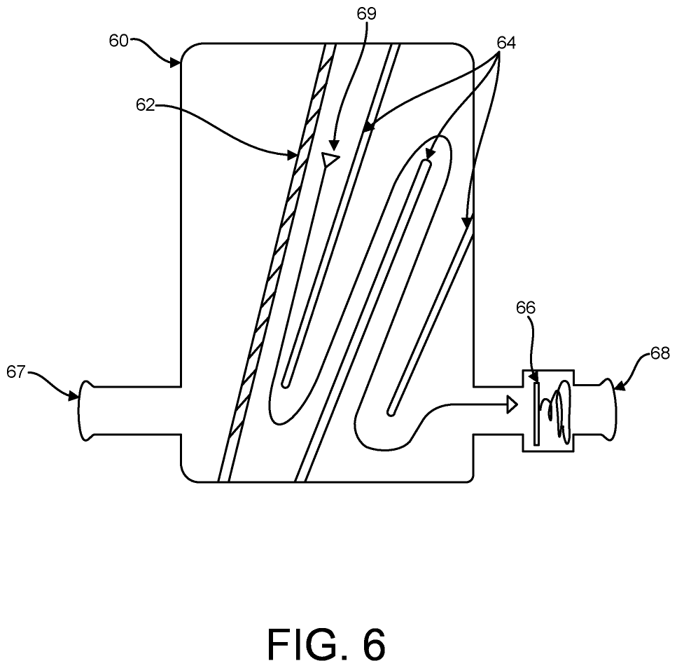

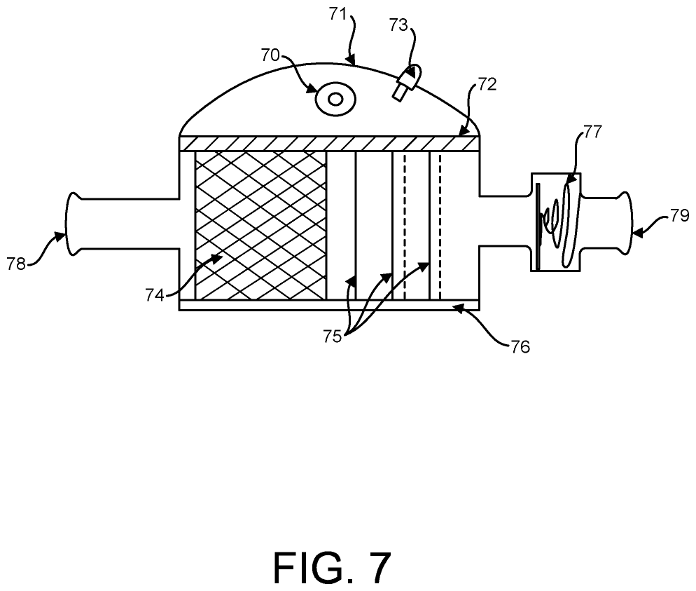

In another embodiment are devices that further contain an in-line sterilization module configured to receive fluid from the reservoir or base of the above embodiments as shown in a top view in FIG. 6 which include a filtration system. Fluid to be further sanitized flow into the module 60 through port 67 and through filter 62 situated at the beginning of the module. The fluid 69 is directed through the module by a series of baffles 64. A check valve 66 is positioned prior to the exit port 68. In a side view of this example FIG. 7, UVC emission sources 70 are position in the top 71 of the module. The filter is shown 74 and baffles 75 are shown which direct the flow direction of the fluids to be sanitized. As above the interior of the module contains UVC reflective surfaces 72 and 76. A light pipe 73 and a check valve 77 are also shown.

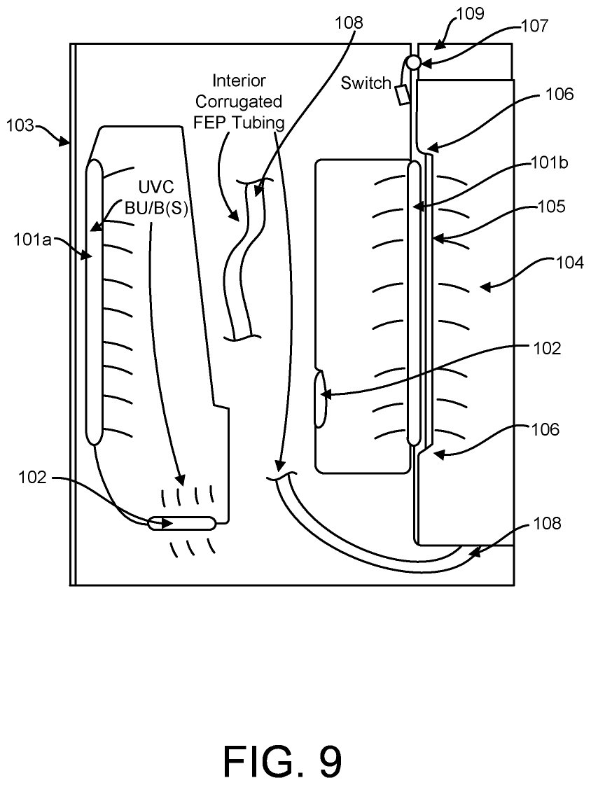

In another embodiment are devices that further contain an in-line sterilization module configured to receive fluid from the reservoir or base of the above embodiments as shown in FIG. 9A and 9B. A clam shell style configuration is shown wherein each half of the clam shell encompass a UVC emission lamp 90. Each half has an inlet 92 and an outlet 93. Each half can be connected in series for extended UVC sterilization or in parallel for increased throughput. An FEP insert may be included 97. As in other embodiments the housing 94 may be constructed of UVC absorbent materials that allow visible light to be seen. The housing may also have UVC reflective surfaces. The module halves are constructed with internal baffles 91 which allow the fluid passing through to undergo a vortex action around the interior of the module. In this manner the fluid sees an increased amount of sterilizing radiation.

FIG. 10 shows an example of the current disclosure applied to a coffee making machine using a corrugated FEP tubing system 108 with silicon joint connectors along with UVC cold cathode UVC lamps 101a and 101b to sterilize the interior of the hose system and at the same time, the water being held in the reservoir 104. Other UVC emitting LEDs 102 may also be strategically place thought the machine as desired to ensure all the internal plumbing is exposed and therefore sterilized. The interior of the coffee maker outer wall 103 may have UVC reflective surfaces. At least one UVC lamp 101b is placed in the center of the outside wall of the tubing system providing exposure to the internal area and plumbing of the coffee pot, along with providing simultaneous UVC exposure to UVC transparent FEP or Quartz windows 105 of the reservoir 104. The quartz or FEP window of the reservoir will protrude 106 into the reservoir to allow full internal exposure of UVC sanitizing radiation while also preventing UVC light escaping through the gap of the reservoir and coffee maker when the lamp is activated. The fluid reservoir and lid 109 will each have a safety switch 107 to turn off the UVC lamp in the case either is lifted to prevent UVC light exposure to humans.

We claim:

1. A fluid sterilizing device comprising:
a. a reservoir comprising a lid, a bottom and sides for containing a fluid comprised of material which is opaque to UVC radiation, at least one window positioned in the bottom of the reservoir for allowing the passage of UVC radiation into the interior of the reservoir,
b. a base component configured to accept the reservoir comprising at least one UVC emission source positioned at the at least one window and positioned to emit UVC radiation into the interior of the reservoir,
wherein the at least one UVC emission source is a UVC cold cathode mercury vapor lamp, a UVC LED or both when more than one UVC source is present and wherein the surface of the lid that is positioned inwardly to the interior of the reservoir has a UVC reflective surface.

2. The device of claim 1, wherein the lid further comprises a shut-off switch configured to disable the UVC transmission from the at least one UVC emission source when the lid opens, and an activation switch situated in the base that activates the UVC emission sources when the reservoir is positioned into or onto the base.

3. The device of claim 2, wherein the UVC emission sources are programmed to activate intermittently, at various intensities and for varying lengths of time.

4. A fluid sterilizing device comprising a reservoir, comprising a lid, a bottom and sides for containing a fluid comprised of material which is opaque to UVC radiation, wherein the lid is comprised of at least one UVC radiation source positioned in the lid such that, in operation, the UVC emission source emits UVC sterilizing radiation into the interior of the reservoir and wherein the interior of the reservoir my optionally be covered with expanded PTFE.

5. The device of claim 4, wherein the at least one UVC emission source is a UVC cold cathode mercury vapor lamp, a UVC LED or both when more than one UVC source is present and wherein the surface of the lid that is positioned inwardly to the interior of the reservoir has a UVC reflective surface.

6. The device of claim 4, wherein the lid further comprises a shut-off switch configured to disable the UVC transmission from the at least one UVC emission source when the lid opens, and an activation switch situated in the base that activates the UVC emission sources when the reservoir is positioned into or onto the base.

7. The device of claim 4, wherein the UVC emission sources are programmed to activate intermittently, at various intensities and for varying lengths of time.

8. The device of claim 1, further comprising an in-line sterilization module configured to receive an output of fluid from the reservoir, comprising,
a. a tubing structure comprised of quartz, FEP or both, situated inside a housing having a UVC reflective interior surface,
b. at least one UVC emission source positioned proximate to the tubing structure,
c. a fluid inlet port and a fluid outlet port, and
d. expanded PTFE reflective materials wrapped around at least a portion of the tubing structure.

9. The device of claim 8, wherein the tubing structure may be a one bend loop, a spiral loop or combinations thereof.

10. The device of claim 1 further comprising an in-line sterilization and filtration module configured to receive an output of fluid from the reservoir, comprising,
a. a filter through which the fluid from the reservoir passes, and
b. a baffling system of at least two vanes, at least one UVC emission source positioned in the module to emit sterilization of the fluid when the fluid passes through the baffle system,
wherein the intensity of the UVC emission is programmable.

11. The device of claim 4 further comprising an in-line sterilization module configured to receive an output of fluid from the reservoir, comprising;
a. a tubing structure comprised in quartz, FEP or both, situated inside a housing having a UVC reflective interior surface,
b. at least one UVC emission source positioned proximate to the tubing structure,
c. a fluid inlet port and a fluid outlet port, and
d. expanded PTFE reflective materials wrapped around at least a portion of the tubing structure.

12. The device of claim 11, wherein the tubing structure may be a one bend loop, a spiral loop or combinations thereof.

13. The device of claim 4, further comprising an in-line sterilization and filtration module configured to receive an output of fluid from the reservoir, comprising,
a. a filter through which the fluid from the reservoir passes, and
b. a baffling system of at least two vanes, at least one UVC emission source positioned in the module to emit sterilization of the fluid when the fluid passes through the baffle system,
wherein the intensity of the UVC emission is programmable.

14. A fluid sterilization device for simultaneous sterilization comprising a. a reservoir component comprising a lid, a bottom and sides for storing fluids, b. a tubing system configured to allow the fluids stored in the reservoir to pass through positioned proximate to the reservoir, c. at least one UVC emitting source positioned between the reservoir and the tubing system configured to emit UVC sterilizing radiation into the reservoir containing stored fluids and, simultaneously, the tubing system through which the stored fluids are transported, wherein the at least one UVC emitting source is a cold cathode mercury vapor lamp, a UVC LED or a combination when more than one UVC source is present, wherein the interior surfaces of the components are UVC emission reflective.

15. The device of claim 11 wherein the tubing system is constructed of corrugated materials which allow UVC sterilizing radiation to pass, wherein the tubing system is constructed of UVC corrugated FEP and connected by silicone connectors.
